(19) United States
(12) Patent Application Publication
(10) Pub. No.: US 2011/0050081 A1
(43) Pub. Date: Mar. 3, 2011

(54) LAMP STRUCTURE OF DUAL-WIRE LIGHTING STRING

(76) Inventor: DE-HUI LIN, Chupei City (TW)

(21) Appl. No.: 12/550,421

(22) Filed: Aug. 31, 2009

(51) Int. Cl. H01J 5/48

(52) U.S. Cl. 313/318.01

(57) ABSTRACT

A lamp structure of a dual-wire lighting string includes an illuminator, a base, a socket, and a bottom member. The socket receives the base to which the illuminator is coupled in a top opening and forms therein positioning slots respectively receiving and retaining piercing conductive plates. A power cord is supported and forced by the bottom member into an open bottom of the socket to have the conductive plates piercing wires of the power cord to electrically engage inner conductive cores of the wires. Thus, the assembling of the lamp and the power cord can be carried out in an automatized manner with machines and the manufacturing costs can be reduced.

### TECHNICAL FIELD OF THE INVENTION

The present invention generally relates to a lighting string, and more particularly to the structure of lamps that are connected to and powered by two electrical wires to make a lighting string.

### DESCRIPTION OF THE PRIOR ART

FIG. 1 of the attached drawings shows the arrangement of a lamp and a power cord of a conventional dual-wire lighting string. The lamp, which is designated at 10, comprises an illuminator 11, a base 12, and a socket 13. The illuminator 11 comprises a light-emitting diode (LED) having two terminal pins 111 and is mounted to the base 12. The socket 13 forms therein a fitting chamber 131 and a receiving chamber 132 for receiving the base 12 therein. The receiving chamber 132 has opposite left and right side walls that define left and right positioning slots 133, 134 respectively. The power cord 20 is formed by first clamping left and right conductive plates 15, 16 to conductive cores 211, 221 of two electrical wires 21, 22 and then positioned into the socket 13 through an open bottom thereof to allow the left and right conductive plates 15, 16 to be fit into the left and right positioning slots 133, 134 of the socket 13 by pulling the wires 21, 22 downward thereby securing the left and right conductive plates 15, 16 in the left and right positioning slots 133, 134. After completion of the assembling of the power cord 20, the base 12 to which the illuminator 11 is mounted is fit into the fitting slot 131 of the socket 13 to have the terminal pins 111 of the illuminator 11 engaging the left and right conductive plates 15, 16 whereby the assembling of the lamp 10 and the power cord 20 is completed.

To couple the conventional lamp 10 to the power cord 20, the left and right conductive plates 15, 16 that are clamped to the electrical wires 21, 22 must be pulled downward to forcibly fit the left and right conductive plates 15, 16 into the left and right positioning slots 133, 134 respectively. This operation can only be done manually. Thus, the assembling operation of the lamp 10 to the power cord 20 cannot be automatized, and this makes the manufacturing costs high.

FIG. 2 shows the arrangement of a lamp and a power cord of a conventional juxtaposing-wire lighting string. The lamp, which is also designated at 10, comprises an illuminator 11, a base 12, a socket 13, and a bottom member 14. The illuminator 11 comprises an LED having two terminal pins 111 and is mounted to the base 12. The socket 13 forms therein a fitting chamber 131 and a receiving chamber 132 for receiving the base 12 therein. The receiving chamber 132 has opposite left and right side walls that define left and right positioning slots 133, 134 respectively. A left conductive plate 15 that has two opposite edges forming barbs 151 and a bottom edge forming piercing tips 152 and a right conductive plate 16 that has two opposite edges forming barbs 161 and a bottom edge forming piercing tips 162 are provided and respectively fit into the left and right positioning slots 133, 134. The power cord 20 is a juxtaposing-wire cable composed of at least three electrical wires that are arranged to juxtapose each other and are directly positioned on the bottom of the socket 13. The bottom member 14 is forcibly pushed upward to drive the juxtaposing wires into the socket 13 to allow the piercing tips 152, 162 of the left and right conductive plates 15, 16 to pierce into the power cord 20 to complete the assembling and electrical engagement therebetween. After completion of the assembling of the power cord 20, the base 12 to which the illuminator 11 is mounted is fit into the fitting slot 131 of the socket 13 to have the terminal pins 111 of the illuminator 11 engaging the left and right conductive plates 15, 16 whereby the assembling of the lamp 10 and the power cord 20 is completed.

The coupling between the lamp and the power cord of the above discussed juxtaposing-wire lighting string requires no clamping of the conductive plates to the wires of the power cord, so that machine based automatization of the assembling operation can be realized. However, such a lamp is of a single-loop arrangement, and a configuration of juxtaposing arrangement of three wires is shown. The more the variation of the loop of the lighting string is, the more the number of the wires will be. Consequently, the manufacturing cost of the lighting string is increased. This again makes the overall cost of production high.

### SUMMARY OF THE INVENTION

The primary purpose of the present invention is to provide a lamp structure of a dual-wire lighting string, which includes piercing conductive plates respectively fit into left and right positioning slots defined in a socket and a bottom member, which forcibly drives a power cord, in a deformed manner, into the bottom of the socket to allow the two conductive plates to respectively pierce into two electrical wires of the cord to electrically connect conductive cores of the wires. With such an arrangement, no clamping of the conductive plates to the electrical wires before assembling of the lamp to the electrical cord and thus machine based automatization of the assembling operation can be realized to reduce the cost of production and improve efficiency of production.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing the arrangement of a conventional lamp of a dual-wire lighting string.

FIG. 2 is an exploded view showing the arrangement of a conventional lamp of a juxtaposing-wire lighting string.

FIG. 3 is an exploded view showing a lamp of the present invention for a decorative lighting string.

FIGS. 4 and 5 are respectively an exploded view in broken form and schematic plan view showing the spatial relationship between the lamp of the present invention and a power cord.

FIG. 6 is a perspective view showing the lamp of the present invention mounted to the power cord.

FIGS. 7 and 8 are cross-sectional views illustrating the connection between the lamp of the present invention and the power cord.

FIGS. 9A-9C are schematic views showing various arrangements of lighting strings in accordance with the present invention.

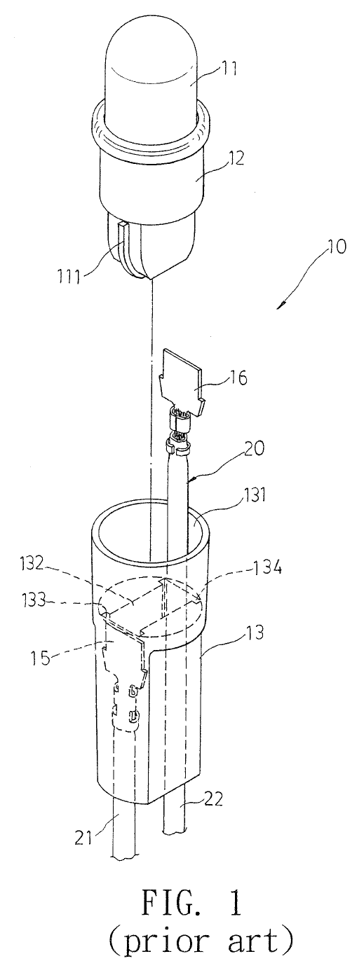

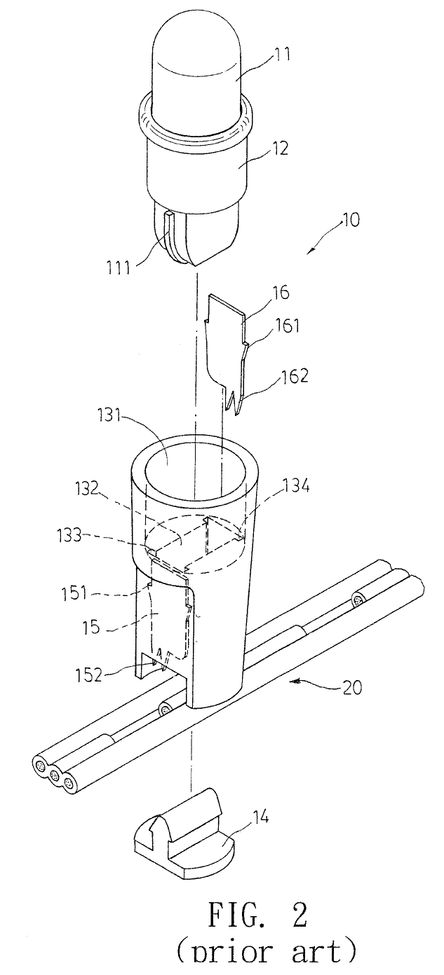

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

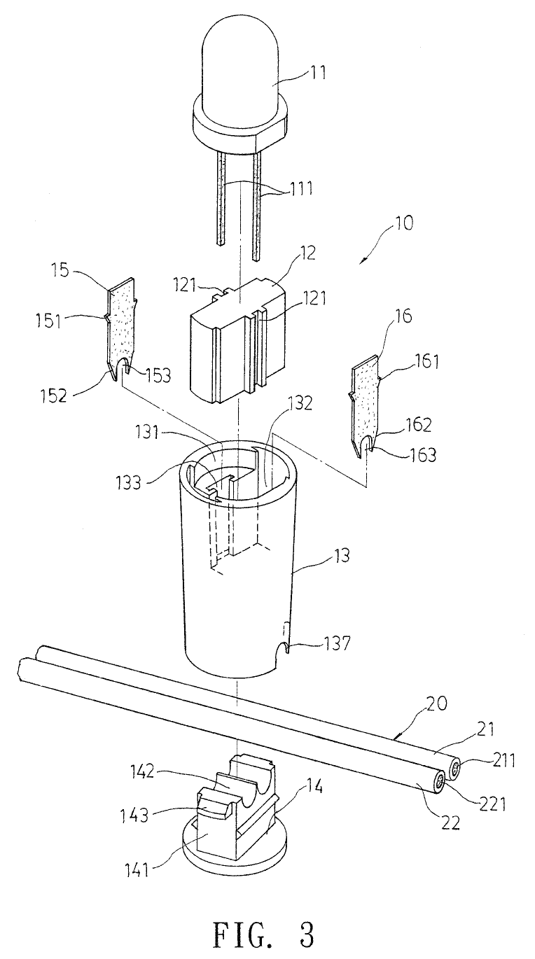

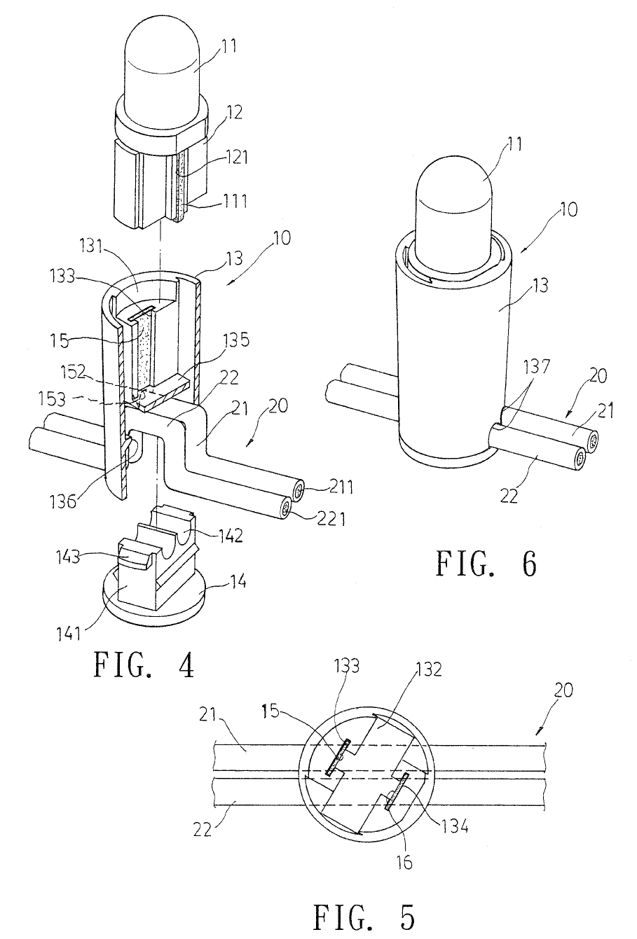

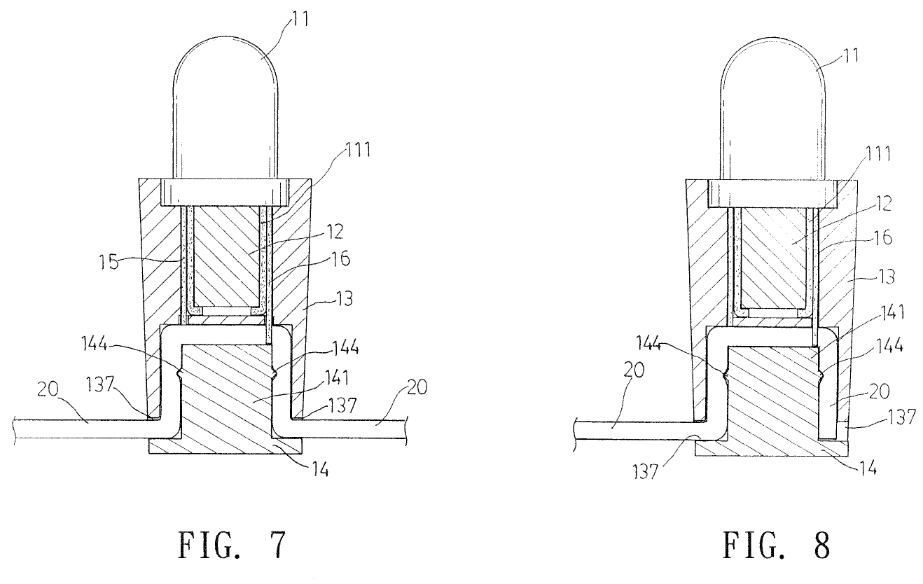

As shown in FIGS. 3-6, the present invention provides a lamp structure of a dual-wire lighting string. The lamp of the present invention, which is generally designated at 10, comprises a bulb or illuminator 11, a base 12, a socket 13, and a bottom member 14. A power cord 20 that supplies power to the lamp 10 is composed of a dual-wire configuration. The illuminator 10 is for example a light-emitting diode (LED) having two conductive terminal pins 111. The base 12 has opposite left and right sides each forming a central projection in which a groove 121 is defined. The grooves 121 function to receive and retain the two terminal pins 111 of the LED therein, thereby coupling the illuminator 11 to the base 12. The socket 13 forms, in a first end portion thereof, a fitting chamber 131 and a receiving chamber 132 communicating each other, for receiving the base 12 to fit therein. A support plate 135 is formed inside the socket 13 to define a bottom of the receiving chamber 132. The receiving chamber 132 has opposite left and right side walls in which left and right positioning slots 133, 134 are respectively defined. The socket 13 has an open second end portion forming an open cavity in which two retention blocks 136 are formed on opposite side walls of the socket 13 below the support plate 135. The open second end of the socket 13 forms, in the side walls thereof, wire slots 137 that are opposite to each other in a direction that is set at an angle less than 90 degrees with respect to the positioning slots 133, 134. A left conductive copper plate 15 that has two opposite edges forming barbs 151 and a bottom edge forming two piercing tips 152 that define therebetween a wire fitting notch 153 at a central portion of the bottom edge and a right conductive copper plate 16 that has two opposite edges forming barbs 161 and a bottom edge forming two piercing tips 162 that define therebetween a wire fitting notch 163 at a central portion of the bottom edge are provided and respectively fit into the left and right positioning slots 133, 134 and are securely retained in the positioning slots 133, 134 by the barbs 151, 161 thereof. The bottom member 14 forms in a central portion thereof a stand 141. The stand 141 has a top forming a receiving channel 142 for receiving and supporting the power cord 20. The stand 141 forms pawls 143 on sides thereof that are opposite left and right sides of the receiving channel 142 and the stand 141 also forms retention ribs 144 on opposite front and rear sides thereof. The power cord 20 is positioned in the wire slots 137 defined in opposite side walls of the second, bottom end of the socket 13. The bottom member 14 receives and supports two wires 21, 22 that constitute the power cord 20 with two recesses defined in the receiving channel 142 and is forced upward to fit into the open bottom end of the socket 13 to position the power cord 20 against the support plate 135. Since the wire slots 137 are formed in opposite side walls of the socket 13 to oppose each other in a direction that is set at a predetermined angle less than 90 degrees with respect to the positioning slots 133, 134, the length of the two wires 21, 22 is set inclined with respect to the left and right conductive copper plates 15, 16 by an angle less than 90 degrees, as best seen in FIG. 5. Under this situation, the two piercing tips 152 of the left conductive copper plate 15 may pierce through an insulation outer cover layer of the wire 21 to have the wire fitting notch 153 fit over and clamping a conductor core 211 of the wire 21 so as to form electrical connection therebetween, and the two piercing tips 162 of the right conductive copper plate 16 may pierce through an insulation outer cover layer of the wire 22 to have the wire fitting notch 163 fit over and clamping a conductor core 221 of the wire 22 so as to form electrical connection therebetween. At the same time, the pawls 143 of the bottom member 14 are forced into engagement with retention blocks 136 of the socket 13 to securely couple the bottom member 14 and the power cord 20 to the socket 13. Since the power cord 20 is pierced through and clamped by the left and right conductive copper plates 15, 16 and is also tightly held by be pressed by the retention ribs 144, as shown in FIGS. 7 and 8, the power cord 20 can maintain secured coupling with the socket 13 even through it is subjected to powerful stretching or pulling. The base 12 to which the LED illuminator 11 is coupled is then fit into the receiving chamber 132 of the socket 13 from the upper side to have the two terminal pins 111 of the LED illuminator 11 respectively engaging the left and right conductive copper plates 15, 16, whereby the assembling of the lamp 10 and the power cord 20 to each other is completed. With the above discussed arrangement, the assembling of the lamp and the power cord can be done without first clamping conductive copper plates around electrical wires, so that the assembling operation can be carried out in an automatized manner with machines and the manufacturing costs can be reduced.

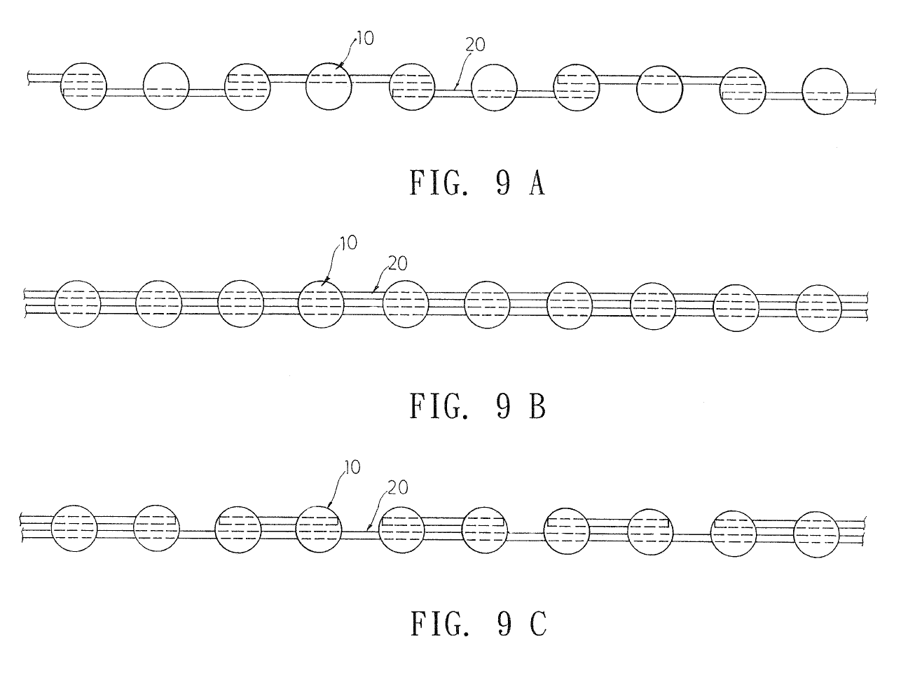

Referring to FIGS. 9A, 9B, and 9C, arrangements of lighting string in accordance with the present invention are schematically illustrated. The lighting string shown in FIG. 9A demonstrates a serial arrangement of the power cords 20 and lamps 10. The lighting string shown in FIG. 9B demonstrates a parallel arrangement of the power cords 20 and lamps 10. The lighting string shown in FIG. 9C demonstrates combined serial and parallel arrangement of the power cords 20 and lamps 10.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A lamp structure adapted for use in a dual-wire lighting string, the lamp comprising an illuminator, a base, a socket, and a bottom member, the illuminator comprising a light-emitting diode having two terminal pins, the base having opposite left and right sides forming grooves for receiving the terminal pins of the illuminator so as to couple the illuminator to the base, the socket forming a fitting chamber and a receiving chamber to respectively receive the illuminator and the base to fit therein, a support plate being formed inside the socket to define a bottom of the receiving chamber, the receiving chamber having opposite left and right side walls in which left and right positioning slots are respectively defined, left and right piercing conductive copper plates being respectively received in the left and right positioning slots, the bottom member forming in a central portion thereof a stand for supporting and forcing two wires that constitute a power cord into an open bottom of the socket to allow the wires to be pierced through by the left and right conductive copper plates that are thus set in electrical engagement with inner conductive cores of the wires to thereby connect the lamp to the power cord.

2. The lamp structure according to claim 1, wherein the socket forms in the open bottom end thereof wire holes that are opposite to each other in a direction that is set at an angle less than 90 degrees with respect to the positioning slots.

3. The lamp structure according to claim 1, wherein the socket forms in the open bottom thereof retention blocks on opposite side walls below the support plate.

4. The lamp structure according to claim 1, wherein the stand of the bottom member has a top forming a receiving channel for receiving and supporting the power cord and the stand forms pawls on sides thereof that are opposite left and right sides of the receiving channel.

5. The lamp structure according to claim 1, wherein the stand of the bottom member has a top forming a receiving channel for receiving and supporting the power cord and the stand forms retention ribs on sides thereof that are opposite front and rear sides of the receiving channel.

6. The lamp structure according to claim 1, wherein each of the left and right conductive copper plates has two opposite edges forming barbs and a bottom edge forming two piercing tips that define therebetween a wire fitting notch at a central portion of the bottom edge.
